(19) United States
(12) Patent Application Publication
(10) Pub. No.: US 2023/0062392 A1
(43) Pub. Date: Mar. 2, 2023

(54) AUTONOMOUS HEADER

(71) Applicant: CNH Industrial America LLC, New Holland, PA (US)

(72) Inventors: Andrew Brokaw, Elgin, IL (US); Trevor Stanhope, Palos Hills, IL (US); Hesam Abbassi, Birmingham, MI (US); Panos Tamamidis, Mount Prospect, IL (US); Samrendra K. Singh, Bolingbrook, IL (US)

(73) Assignee: CNH Industrial America LLC, New Holland, PA (US)

(21) Appl. No.: 17/412,855

(22) Filed: Aug. 26, 2021

(51) Int. Cl. A01D 41/14; G01S 17/89

(52) U.S. Cl. CPC A01D 41/141; G01S 17/89; A01D 41/145

(57) ABSTRACT

A control system of an agricultural harvester for controllably harvesting a crop material includes: a lidar sensor configured for sensing a field condition in a forward path of travel of the agricultural harvester and thereby for outputting a field condition signal corresponding thereto; and a controller operatively coupled with the lidar sensor and a header assembly of the agricultural harvester configured for removing the crop material from a field, the controller configured for receiving the field condition signal and for outputting an adjustment signal to raise the header assembly, based at least partially on the field condition signal, when the agricultural harvester reaches an end of a plurality of crop rows.

### FIELD OF THE INVENTION

The present invention pertains to an agricultural harvester, and, more specifically, to a combine header reel.

### BACKGROUND OF THE INVENTION

An agricultural harvester known as a “combine” is historically termed such because it combines multiple harvesting functions with a single harvesting unit, such as picking, threshing, separating, and cleaning. A combine includes a header which removes the crop from a field, and a feeder housing which transports the crop matter into a threshing rotor. The threshing rotor rotates within a perforated housing, which may be in the form of adjustable concaves, and performs a threshing operation on the crop to remove the grain. Once the grain is threshed it falls through perforations in the concaves onto a grain pan. From the grain pan the grain is cleaned using a cleaning system, and is then transported to a grain tank onboard the combine. A cleaning fan blows air through the sieves to discharge chaff and other debris toward the rear of the combine. Non-grain crop material such as straw from the threshing section proceeds through a residue handling system, which may utilize a straw chopper to process the non-grain material and direct it out the rear of the combine. When the grain tank becomes full, the combine is positioned adjacent a vehicle into which the grain is to be unloaded, such as a semi-trailer, gravity box, straight truck, or the like, and an unloading system on the combine is actuated to transfer the grain into the vehicle.

More particularly, a rotary threshing or separating system includes one or more rotors that can extend axially (front to rear) or transversely (side to side) within the body of the combine, and which are partially or fully surrounded by perforated concaves. The crop material is threshed and separated by the rotation of the rotor within the concaves. Coarser non-grain crop material such as stalks and leaves pass through a straw beater to remove any remaining grains, and then are transported to the rear of the combine and discharged back to the field. The separated grain, together with some finer non-grain crop material such as chaff, dust, straw, and other crop residue are discharged through the concaves and fall onto a grain pan where they are transported to a cleaning system. Alternatively, the grain and finer non-grain crop material may also fall directly onto the cleaning system itself.

A cleaning system further separates the grain from non-grain crop material, and typically includes a fan directing an airflow stream upwardly and rearwardly through vertically arranged sieves which oscillate in a fore and aft manner. The airflow stream lifts and carries the lighter non-grain crop material towards the rear end of the combine for discharge to the field. Clean grain, being heavier, and larger pieces of non-grain crop material, which are not carried away by the airflow stream, fall onto a surface of an upper sieve (also known as a chaffer sieve), where some or all of the clean grain passes through to a lower sieve (also known as a cleaning sieve). Grain and non-grain crop material remaining on the upper and lower sieves are physically separated by the reciprocating action of the sieves as the material moves rearwardly. Any grain and/or non-grain crop material which passes through the upper sieve, but does not pass through the lower sieve, is directed to a tailings pan. Grain falling through the lower sieve lands on a bottom pan of the cleaning system, where it is conveyed forwardly toward a clean grain auger. The clean grain auger conveys the grain to a grain elevator, which transports the grain upwards to a grain tank for temporary storage. The grain accumulates to the point where the grain tank is full and is discharged to an adjacent vehicle such as a semi-trailer, gravity box, straight truck or the like by an unloading system on the combine that is actuated to transfer grain into the vehicle.

The operator of a combine has a multitude of tasks to accomplish in order to operate the combine effectively and safely. One such task is maintaining the header at an appropriate height as the combine traverses the ground. Rises or depressions in the ground contour, for instance, require the operator to raise or lower the header, respectively, to maintain a proper height of the header above the ground in order to harvest the crop material properly. Additionally, the operator typically raises the header when the combine reaches an end of a crop row and thus enters the headland (which can also be referred to as the endrow), which generally is a strip of land at least partially circumscribing a field of crop, so that for example travel in headland is more easily facilitated and obstructions that could damage header are avoided. After turning around in the headland and aligning the combine on a new set of rows of unharvested crop, the operator typically lowers the header to begin traversing the rows and thereby harvesting the crop. The operator may also use the headland as a way to traverse a field and thereby exit the field (or enter it and travel to the point at which the operator will begin harvesting in the rows of crop) without traveling through a field of unharvested crops or otherwise when not harvesting. This burden of raising and lowering of the header in and around the headland can be compounded as the operator monitors the overall harvesting operations of the combine and the presence of any other combines or vehicles in the vicinity.

What is needed in the art is a way to automatically raise the header at the end of a row of crop material.

### SUMMARY OF THE INVENTION

The present invention provides a control system for automatically raising the header at the end of a row of crop material.

The invention in one form is directed to a control system of an agricultural harvester for controllably harvesting a crop material, the control system including: a lidar sensor configured for sensing a field condition in a forward path of travel of the agricultural harvester and thereby for outputting a field condition signal corresponding thereto; and a controller operatively coupled with the lidar sensor and a header assembly of the agricultural harvester configured for removing the crop material from a field, the controller configured for receiving the field condition signal and for outputting an adjustment signal to raise the header assembly, based at least partially on the field condition signal, when the agricultural harvester reaches an end of a plurality of crop rows.

The invention in another form is directed to an agricultural harvester, including: a header assembly configured for removing a crop material from a field; a lidar sensor configured for sensing a field condition in a forward path of travel of the agricultural harvester and thereby for outputting a field condition signal corresponding thereto; and a controller operatively coupled with the lidar sensor and the header assembly, the controller configured for receiving the field condition signal and for outputting an adjustment signal to the header assembly to raise the header assembly, based at least partially on the field condition signal, when the agricultural harvester reaches an end of a plurality of crop rows. The invention in yet another form is directed to a method of controllably operating an agricultural harvester, the method including the steps of: providing that the agricultural harvester includes a header assembly which is configured for removing a crop material from a field; sensing, by a lidar sensor, a field condition in a forward path of travel of the agricultural harvester; outputting, by the lidar sensor, a field condition signal corresponding to the field condition; receiving, by a controller operatively coupled with the lidar sensor and the header assembly, the field condition signal; and outputting, by the controller, an adjustment signal to the header assembly and thereby raising the header assembly, based at least partially on the field condition signal, when the agricultural harvester reaches an end of a plurality of crop rows.

An advantage of the present invention is that the operator does not have to raise the header at the end of a crop row.

Another advantage of the present invention is that the operator does not have to lower the header at the beginning of a crop row.

### BRIEF DESCRIPTION OF THE DRAWINGS

For the purpose of illustration, there are shown in the drawings certain embodiments of the present invention. It should be understood, however, that the invention is not limited to the precise arrangements, dimensions, and instruments shown. Like numerals indicate like elements throughout the drawings. In the drawings:

FIG. 1 illustrates a side view of an exemplary embodiment of an agricultural vehicle, the agricultural vehicle including a header assembly and a control system, in accordance with an exemplary embodiment of the present invention;

FIG. 2 illustrates schematically a top view of the agricultural vehicle of FIG. 1 performing a harvesting operation, in accordance with exemplary embodiments of the present invention;

FIG. 3 illustrates schematically a side view of the agricultural vehicle of FIG. 1 performing a harvesting operation, in accordance with exemplary embodiments of the present invention;

FIG. 4 illustrates a schematic diagram of the control system of the agricultural vehicle of FIG. 1, in accordance with an exemplary embodiment of the present invention; and

FIG. 5 illustrates a flow diagram showing a method of controllably performing work, in accordance with an exemplary embodiment of the present invention.

### DETAILED DESCRIPTION OF THE INVENTION

The terms “grain”, “straw” and “tailings” are used principally throughout this specification for convenience but it is to be understood that these terms are not intended to be limiting. Thus “grain” refers to that part of the crop material which is threshed and separated from the discardable part of the crop material, which is referred to as non-grain crop material, MOG or straw. Incompletely threshed crop material is referred to as “tailings”. Also, the terms “forward”, “rearward”, “left” and “right”, when used in connection with the agricultural harvester and/or components thereof are usually determined with reference to the direction of forward operative travel of the harvester, but again, they should not be construed as limiting. The terms “longitudinal” and “transverse” are determined with reference to the fore-and-aft direction of the agricultural harvester and are equally not to be construed as limiting. The terms “downstream” and “upstream” are determined with reference to the intended direction of crop material flow during operation, with “downstream” being analogous to “rearward” and “upstream” being analogous to “forward.”

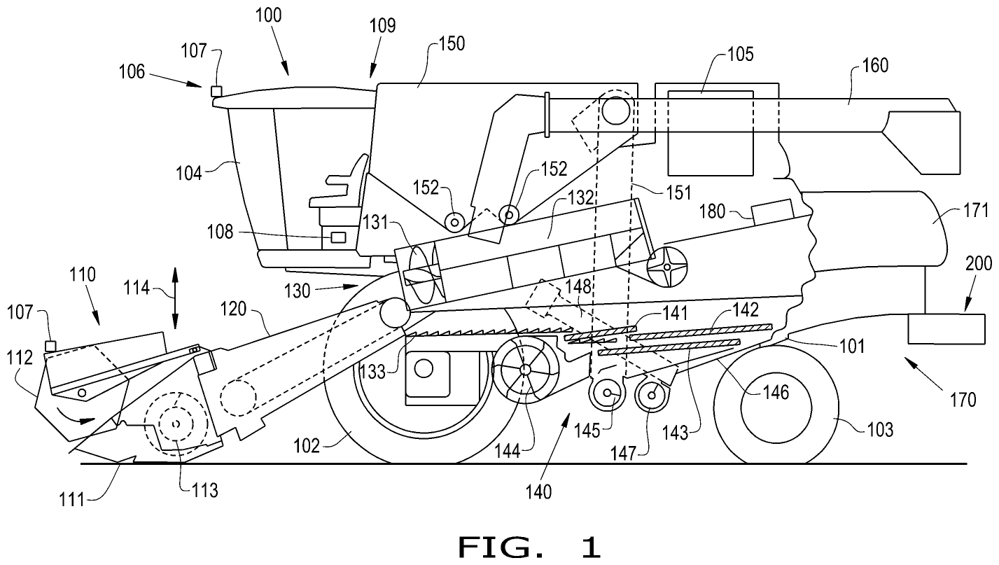

Referring now to the drawings, and more particularly to FIG. 1, there is shown an embodiment of an agricultural harvester 100 in the form of a combine which generally includes a chassis 101, ground engaging wheels 102 and 103, header 110 (which can be referred to as a header assembly 110 and which is configured for removing a crop material 206 from a field 205), feeder housing 120, operator cab 104, threshing and separating system 130, cleaning system 140, grain tank 150, and unloading conveyance 160. Front wheels 102 are larger flotation type wheels, and rear wheels 103 are smaller steerable wheels. Motive force is selectively applied to front wheels 102 through a power plant in the form of a diesel engine 105 and a transmission (not shown). Although combine 100 is shown as including wheels, is also to be understood that combine 100 may include tracks, such as full tracks or half tracks.

Header 110 is mounted to the front of combine 100 and includes a cutter bar 111 for severing crops from a field during forward motion of combine 100. A rotatable reel 112 feeds the crop into header 110, and a double auger 113 feeds the severed crop laterally inwardly from each side toward feeder housing 120. Feeder housing 120 conveys the cut crop to threshing and separating system 130, and is selectively vertically movable using appropriate actuators, such as hydraulic cylinders (not shown).

Threshing and separating system 130 is of the axial-flow type, and generally includes a threshing rotor 131 at least partially enclosed by a rotor cage and rotatable within a corresponding perforated concave 132. The cut crops are threshed and separated by the rotation of rotor 131 within concave 132, and larger elements, such as stalks, leaves and the like are discharged from the rear of combine 100. Smaller elements of crop material including grain and non-grain crop material, including particles lighter than grain, such as chaff, dust and straw, are discharged through perforations of concave 132. Threshing and separating system 130 can also be a different type of system, such as a system with a transverse rotor rather than an axial rotor, etc.

Grain which has been separated by the threshing and separating assembly 130 falls onto a grain pan 133 and is conveyed toward cleaning system 140. Cleaning system 140 may include an optional pre-cleaning sieve 141, an upper sieve 142 (also known as a chaffer sieve or sieve assembly), a lower sieve 143 (also known as a cleaning sieve), and a cleaning fan 144. Grain on sieves 141, 142 and 143 is subjected to a cleaning action by fan 144 which provides an air flow through the sieves to remove chaff and other impurities such as dust from the grain by making this material airborne for discharge from a straw hood 171 of a residue management system 170 of combine 100. Optionally, the chaff and/or straw can proceed through a chopper 180 to be further processed into even smaller particles before discharge out of the combine 100 by a spreader assembly 200. It should be appreciated that the “chopper” 180 referenced herein, which may include knives, may also be what is typically referred to as a “beater”, which may include flails, or other construction and that the term “chopper” as used herein refers to any construction which can reduce the particle size of entering crop material by various actions including chopping, flailing, etc. Grain pan 133 and pre-cleaning sieve 141 oscillate in a fore-to-aft manner to transport the grain and finer non-grain crop material to the upper surface of upper sieve 142. Upper sieve 142 and lower sieve 143 are vertically arranged relative to each other, and likewise oscillate in a fore-to-aft manner to spread the grain across sieves 142, 143, while permitting the passage of cleaned grain by gravity through the openings of sieves 142, 143.

Clean grain falls to a clean grain auger 145 positioned crosswise below and toward the front of lower sieve 143. Clean grain auger 145 receives clean grain from each sieve 142, 143 and from a bottom pan 146 of cleaning system 140. Clean grain auger 145 conveys the clean grain laterally to a generally vertically arranged grain elevator 151 for transport to grain tank 150. Tailings from cleaning system 140 fall to a tailings auger trough 147. The tailings are transported via tailings auger 147 and return auger 148 to the upstream end of cleaning system 140 for repeated cleaning action. A pair of grain tank augers 152 at the bottom of grain tank 150 convey the clean grain laterally within grain tank 150 to unloader 160 for discharge from combine 100.

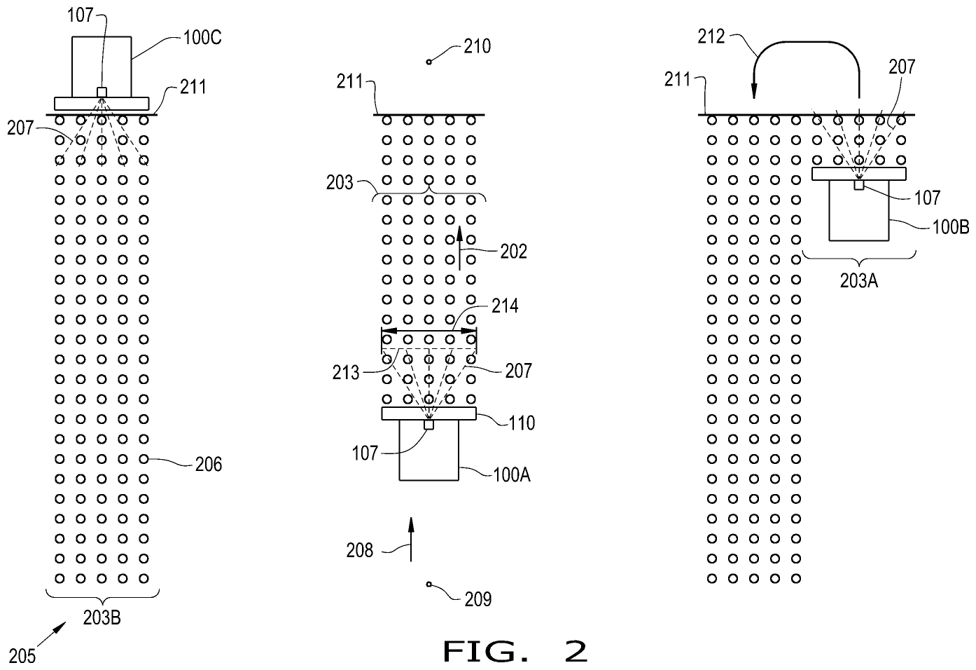

FIG. 1 also includes a control system 106 for combine 100 for controllably harvesting crop material 200 (FIG. 2). The control system includes a sensor 107 formed as a lidar sensor (referred herein as sensor or lidar sensor), and a controller 108 operatively coupled with lidar sensor 107 and a header 110, sensor 107 and controller 108 both being schematically shown in FIG. 1 and can take on any suitable form known in the art. Sensor 107 is shown in FIG. 1 attached to a front portion 109 of combine 100, namely, at or near cab 104. Another sensor 107 is shown in FIG. 1 attached to header 110 (but is not shown in other figures). Though two sensors 107 are shown, it will be appreciated that only one sensor 107 need be attached to combine 100, or, alternatively, more than two sensors 107 can be employed, in an array across header 110 and/or on or near cab 104, or at other suitable locations on combine 100. In terms of location, sensor 107 needs to be able to sense what is in front of combine 100 in a forward path of travel 202 of combine 100. Further, controller 108 is schematically positioned in FIG. 1, but could be positioned in any suitable location(s) of combine 100. Further, control system 106 is shown in FIG. 1 in combination with an exemplary embodiment of combine 100 and header 110. It will be appreciated that any type of combine or header may be used in accordance with the present invention, such that a variety of crop materials can be harvested. Further, header 110 can be raised and lowered, as indicated by bi-directional arrow 114 (which is shown as vertical, but it is understood that header 110 can be pivotally attached to a front end of the body of combine 100 so as to pivot generally vertically about a transverse axis), can be titled laterally and/or fore and aft, and can articulate (flex) or be rigid. Though addressed in more detail below, in sum lidar sensor 107 is configured for sensing a field condition in forward path of travel 202 of combine 100 and thereby for outputting a field condition signal corresponding to the field condition, and controller 108 is configured for receiving the field condition signal and for outputting an adjustment signal, based at least partially on the field condition signal. That adjustment signal can be, for example, to raise header 110 when combine 100 reaches an end of a first plurality of crop rows 203A, or to lower header 110 when combine 100 is about to begin traversing the field at a second plurality of crop rows 203B.

Sensor 107 is a lidar sensor 107 that uses lidar technology to sense range, that is, distance, to an object, whatever that object may be, i.e., ground, vegetation, buildings, riverbed, etc. Lidar is an abbreviation for, variously, “light detection and ranging,” and “laser imaging, detection, and ranging.” In general, a lidar sensor uses light, as opposed to sound or radio waves, to find a distance to an object, and the light can be ultraviolet, visible, or near infrared light. To find the distance to an object, the basic equation of distance (d) being in terms of velocity (v) and time (t) is employed, namely, d=vt, wherein v is the speed of light (c). A lidar sensor sends out a pulse of light to an object. This pulse of light is reflected off of the object and travels back to the lidar sensor, which receives the pulse and tracks the amount of time it took for the pulse of light to travel the distance to and from the object. To calculate the distance to the object, from a known reference point (whether on the ground or in the air or otherwise), as opposed the full path of travel to and from the object, d=ct/2. When scanning a relatively large area (as in mapping), large numbers of pulses of light per second are sent out and received by the lidar sensor, which generates for each pulse a three-dimensional (xyz) coordinate, a location point in space. The points together form a three-dimensional data set, a point cloud, which point cloud processing software can use to generate a three-dimensional model, a map, of what has been scanned. Lidar sensors can be used on stationary or mobile platforms to generate the three-dimensional map. This is referred to as time-of-flight technology, and is well-known in the art.

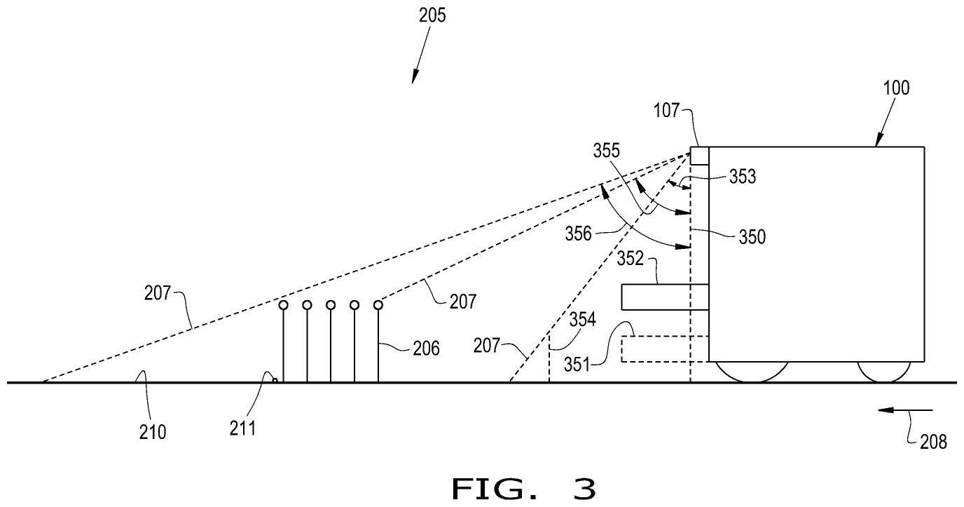

Referring now to FIG. 2, there is shown a schematic view of a harvesting operation with three separate combines 100A, 100B, and 100C (each being shown as schematic versions of combine 100) in a field 205 of crop material 206 disposed in a plurality of rows 203. Each combine 100A, 100B, 100C is shown in operation but at different locations in field 205. Each has a sensor 107 mounted about the top front of cab 104, which sends out and receives pulses 207 of light and thereby scans what lies to the front of the respective combine 100A, 100B, 100C in a forward direction of travel 208, more specifically, what lies in the forward path of travel 202, even more specifically, what lies in front of header 110, whether that be crop material 206 or open ground 209 in field 205. Sensor 107 of combine 100A is shown radiating pulses of light 207 in front of header 110 along a transverse line 213 that has a length 214 which is substantially equal to a length of header 110. Use of lidar sensor 107 provides for real-time three-dimensional mapping of what lies in front of combine 100, which can be used to adjust header 110, in accordance with the present invention. Open ground 209 is shown behind combine 100A (the crop material 206 having already been harvested), and also in a headland 210. Regarding combine 100A, combine 100A is shown in substantially a middle of field 205 between a beginning of a plurality of rows which header 100 of combine 100A spans and the end of the rows. The light pulses 207 from lidar sensor 107 senses standing crop material 206 in front of header 110, such that controller 108 associated with combine 100A would not raise header 110 based on an absence of crop material 206. Regarding combine 100B, combine 100B is approaching an end of the rows 203A of crop material 206 that combine 100B is harvesting. With light pulses 207 radiating from lidar sensor 107 into headland 210, lidar sensor 107 has already sensed an end to crop material 206 at the juxtaposition or dividing line 211 of the rows 203A of crop material 206 and headland 210. Given that the position of combine 100 is known, for example, by way of a global positioning system (GPS) as part of lidar sensor 107, a GPS of combine 100B, or a combination thereof, and that the position of the beginning of headland 210 is known by an absence of crop material 206 from sensor 107, header 110 of combine 100B has not yet lifted. However, according to an embodiment of the present invention, control system 106 will automatically lift header 110 once header reaches dividing line 211. Header 110 will be raised from a crop removal position 351 (also shown in FIG. 1) to a headland position 352 (FIG. 3). Crop removal position 351 need not be a single position but can be a range of positions suitable for removing crop material 206 under a given set of operating conditions but which is nevertheless lower in height than headland position 352, which can be set, such as by the operator, at a predetermined height. Upon reaching headland 210, the operator of combine 100B, under this scenario, can turn left or right and may, for example, exit field or continue harvesting by turning 180° in headland 210 and realigning combine 100B with a new set of rows of crop material 206 to be harvested, as indicated by U-shaped arrow 211. Regarding combine 100C, combine 100C has, for example, already made a turn similar to U-shaped arrow 212 and is ready to begin harvesting the set of rows 203B of crop material 206 lying directly in front of it. As indicated by light pulses 207 from lidar sensor 107 of combine 100C, this sensor 107 senses the presence of crop material 206 directly in front of combine, and thus controller 108 lowers header 110 of combine 100C to crop removal position 351.

Referring now to FIG. 3, there is shown schematically a side view of combine 100 before which is standing crop material 206 in forward path 202 of travel. Light pulses 207 are shown radiating from lidar sensor 107. In exemplary embodiment of the present invention, the light pulses 207 radiate from sensor 107 at a predetermined scanning angle (set by the manufacturer of combine 100, or, optionally, by the operator) from a vertical line 350, such as angle 353, and scan left and right repeatedly across the length 214 of the forward path of travel, the scanning angle remaining constant during a harvesting operation; alternatively, scanning angles can optionally vary while harvesting crop material 207, such that lidar sensor scans not only left and right repeatedly but fore and aft as well, but it is discussed herein as scanning only left and right. For illustrative purposes only, however, a plurality of scanning angles 353, 355, 356 are shown in FIG. 3, to illustrate different scenarios.

At scanning angle 353 (corresponding to the first scenario), combine 100 approaches rows of crop material 206 to begin harvesting the rows. Initially, lidar sensor 107 senses only the ground, not crop material, leading controller 108 to make the determination to leave header 110 in headland position 352. The following describes an exemplary embodiment on how this determination can be made, according to the present invention, though other ways fall within the scope of the present invention. That is, with sensor 107 set at predetermined angle 353, sensor 107 can measure the distance from sensor to a point on a horizontal plane beneath the wheels of combine 100. This distance (distance A, shown as the full length of broken lines associated with angle 353 in FIG. 3) can serve as a basis for comparison, such that when a measured distance is less than distance A controller 108 can ascertain that an object higher than the ground stands in forward path of travel 202. For example, with vertical line 354, it can be seen in FIG. 3 that the full length of the broken line associated with angle 353 from sensor 107 to the ground is longer than the distance along that same broken line from sensor 107 to the top of vertical line 354.

So that controller 108 does not move header 110 from crop removal position 351 to headland position 352, or vice versa, at inappropriate times, a threshold distance can be set in controller 108, which can correspond to an estimated or actual average crop height, which can be referred to as a threshold crop height. The threshold crop height can, for example, be according to the operator's estimate of the average crop height, or some lesser height which would not otherwise trigger moving header 110 at inappropriate times. This threshold crop height being entered into control system 106 (such as by way of an operator's input device 401) prior to harvesting. On the other hand, sensor 107 can pre-scan standing crop material 206 from headland 210, with actual measurements of the height of crop material 206 being taken, which can be used to develop a threshold crop height. Alternatively, controller 108 may access a database that includes such information as average crop height for a specific geographic area, or controller 108 may calculate an estimated average crop height considering various conditions during the growing season that would affect crop growth. Alternatively, a combination of any of the aforementioned ways of ascertaining a threshold average crop height can be utilized, or any other suitable manner. Regardless of the manner of determining the threshold crop height, this value is used to trigger the raising and lowering of header 110, or, some value less than this value can be used as the threshold crop height, to account for margins of error. For instance, the length of broken line 354 in FIG. 3 could be used as the threshold crop height. Thus, if sensor 107 senses a distance equal to or less than the distance (distance B) from sensor 107 to the top of vertical line 354, then controller moves header 110 to crop removal position 351, or otherwise leaves header 110 in that position. Conversely, if sensor 107 senses a distance greater than distance B, then controller moves header 110 to headland position 352, or otherwise leaves header 110 in that position.

At angle 355, sensor 107 has already detected the predetermined threshold crop height to trigger the lowering of header 110 to crop removal position 351. However, so that header is not lowered too soon, a threshold distance corresponding to the horizontal distance between sensor 107 and the crops in a foreground can be set in control system 106. That is, though controller is “preparing” to lower header 110 to crop removal position upon detecting a distance associated with the threshold crop height, controller 108 may delay this lowering until header 110 is within a short, predetermined distance of crop material 206, for example, three meters, or some other desirable distance. Such a distance can be preset in controller 108, and a known position of combine 100 and the sensed position of the beginning of the crop material 206 can be used to determine when to lower header 110 to crop removal position 351.

At angle 356, sensor 107 “sees” beyond crop material 206 and into headland 210, having sensed the known distance to ground, which is too long for there to be crop material 206. Controller is now “preparing” to raise header 110 to headland position 352, which it can do based upon a known position of combine 100 and a sensed position of dividing line 211 (knowing the position of the last of crop material 206 before headland 210), and can raise header 110 to headland position 352 at dividing line 211. Alternatively, at angle 356 controller 108 can determine that combine 100 has neared headland 210 when sensor 107 senses a sudden predetermined increase in distance corresponding to a drop in height to level ground. Conversely, controller 108 can determine that combine has neared standing crop material 206 while in, for example, headland 210 when sensor 107 senses a sudden decrease in distance corresponding to an increase in height from level ground, namely, the threshold crop height.

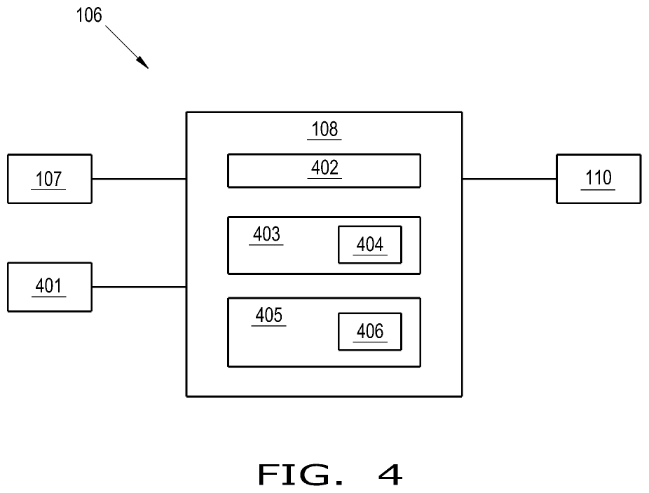

In sum, lidar sensor 107 is configured for sensing a first field condition—that is, an absence of crop material 206 in forward path of travel 202, as in headland 210 and associated with angles 353, 356—in forward path of travel 202 and thereby for outputting a first field condition signal (indicated in FIG. 4 by connecting lines) corresponding thereto. Controller 108 is configured for receiving the first field condition signal and for outputting a first adjustment signal (as indicated in FIG. 4 by connecting lines) to raise header 110 to headland position 352, based at least partially on the first field condition signal, when combine 100 reaches an end of a first plurality of crop rows 203A. Further, lidar sensor 107 is configured for sensing a second field condition—that is, a presence of the crop material 206 in forward path of travel 202, as in what is associated with angle 355—in forward path of travel 206 and thereby for outputting a second field condition signal corresponding thereto. Controller 108 is configured for receiving the second field condition signal (indicated in FIG. 4 by connecting lines) and for outputting a second adjustment signal (as indicated in FIG. 4 by connecting lines) to lower header 110 to crop removal position 351, based at least partially on the second field condition signal, when combine 100 is about to begin traversing field 205 at a second plurality of crop rows 203B. Further, the first field condition signal can be associated with a predetermined threshold crop height and/or a predetermined threshold change in a distance sensed by lidar sensor 107, namely an increase. Conversely, the second field condition signal can be associated with a predetermined threshold crop height and/or a predetermined threshold change in a distance sensed by lidar sensor 107, namely a decrease. The threshold change can correspond to the difference between distance A and distance B.

Referring now to FIG. 4, there is shown a schematic diagram of control system 106, according to an exemplary embodiment of the present invention. Control system 106 includes, for example, lidar sensor 107, an operator input device 401 (such as a laptop, handheld computer device, or onboard computer device in cab), header 110, and controller 108, lidar sensor 107 and operator input device 401 being, at least in part, input devices, and header 110 being, at least in part, an output device. Controller 108 can receive input signals (such as field condition signals from lidar 107, and the predetermined threshold crop height and the threshold change from operator input device 401) from lidar sensor 107 and operator input device 401 and can output signals (such as adjustment signals) to header 110, as indicated by connecting lines in FIG. 4. Thus, controller 108 is operatively coupled with lidar sensor 107, operator input device 401, and header 110. Controller 108 can also be operatively coupled with a variety of other systems of combine 100, such as engine control, steering, and a transmission, to name just a few.

In general, controller 108 may correspond to any suitable processor-based device(s), such as a computing device or any combination of computing devices. Thus, as shown in FIG. 4, controller 108 may generally include one or more processor(s) 402 and associated memory 403 configured to perform a variety of computer-implemented functions (e.g., performing the methods, steps, algorithms, calculations and the like disclosed herein). For instance, lidar sensor 107 and operator input device 401 may each include a processor 402 therein (as can a combine main controller), as well as associated memory, data, and instructions, each forming at least part of controller 108. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, memory 403 may generally include memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD), and/or other suitable memory elements. Such memory 403 may generally be configured to store information accessible to the processor(s) 402, including data 404 that can be retrieved, manipulated, created, and/or stored by processor(s) 402 and instructions 405 that can be executed by the processor(s) 402. In some embodiments, data 404 may be stored in one or more databases.

Accordingly, more specifically, controller 108 receives certain inputs and transmits certain outputs. For example, controller 108 receives input signals from lidar sensor 107 concerning the presence or absence of crop material 206 at certain positions in field 205 and the position of combine 100 (such positioning of combine 100 can alternatively or in addition thereto come from a separate GPS system associated with combine 100), and operator input device 401 concerning the predetermined threshold crop height and/or the predetermined threshold change. Controller 108 can form an adjustment module 406 to adjust header 110 from crop removal position 351 to headland position 352, or vice versa, based at least partly on this input information, as well as on an algorithm and data 404 stored in memory 403 such as the current actual position of combine 100 and header 110, and controller 108 can output a signal to header 110 based on adjustment module 406.

In use, the operator can operate combine 100 without the operator needing to decide to raise header 110 to headland position 352 upon entry into headland 210 after harvesting a set of rows 203 of crop material or to lower header 110 to crop removal position 351 upon lining up to harvest a select set of rows 203 of crop material 206. The operator can input into controller 108 by way of suitable input device 401 in cab, for example, a predetermined threshold crop height and/or a predetermined change (whether increasing or decreasing). When operator is harvesting a select set of rows 203 of crop material 206 and control system 106 senses an end of the row 203 of crops 206, control system 106 can automatically raise header 110 to headland position 352 at the end of the rows 203, based at least partially on information from sensor 107, the thresholds, and also on control system 106 knowing the position of combine 100 in relation to the end of the rows 203, such as by way of a GPS in lidar sensor 107 (presumed in FIG. 4) or a separate GPS in combine 100. After reaching headland 210, the operator can turn combine 100 around in headland 210 with header 110 in headland position 352. After the operator turns combine 100 around and realigns combine 100 with a new set of rows 203 of crop 206 to harvest, control system 106 can automatically lower header 110 to crop removal position 351 at the beginning of rows 203, based at least partially on information from sensor 108, the thresholds, and control system's 106 awareness of the location of combine 100.

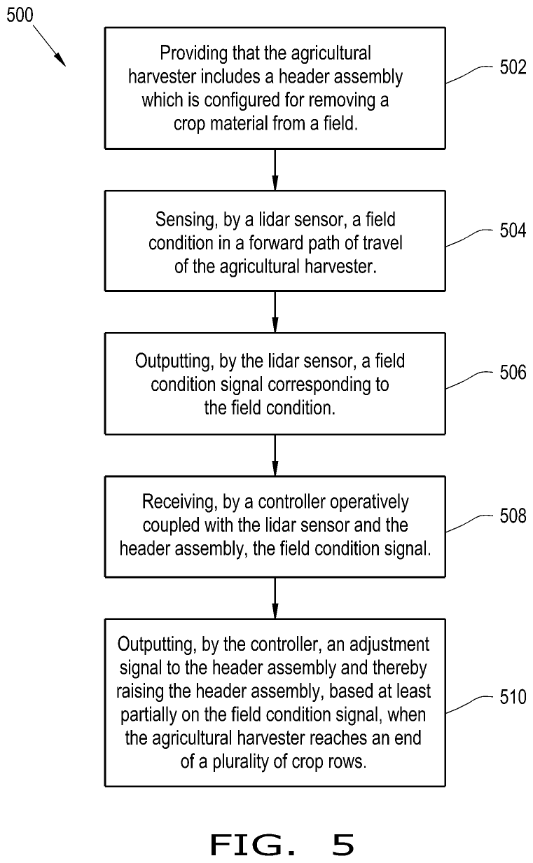

Referring now to FIG. 5, there is shown a method 500 of controllably operating combine 100. The method includes the steps of: providing 502 that combine 100 includes header 110 which is configured for removing crop material 206 from field 205; sensing 504, by lidar sensor 107, a field condition in a forward path of travel 202 of combine 100; outputting 506, by lidar sensor 107, a field condition signal corresponding to the field condition; receiving 508, by controller 108 operatively coupled with lidar sensor 107 and header 110, the field condition signal; and outputting 510, by controller, an adjustment signal to header 110 and thereby raising header 110, based at least partially on the field condition signal, when combine 100 reaches an end of a plurality of crop rows 203. The field condition 205 can be a first field condition, the field condition signal can be a first field condition signal, the adjustment signal can be a first adjustment signal, the plurality of crop rows can be a first plurality of crop rows 203A, and the first field condition can be an absence of crop material 206 in forward path of travel 202. The first field condition signal can be associated with a predetermined threshold crop height and/or a predetermined threshold change in a distance sensed by lidar sensor 107. The method can further include the steps of: sensing, by lidar sensor 107, a second field condition in the forward path of travel 202 of combine 100; outputting, by lidar sensor 107, a second field condition signal corresponding to the second field condition; receiving, by controller 108, the second field condition signal; outputting, by controller 108, a second adjustment signal to header 110 and thereby lowering header 110, based at least partially on the second field condition signal, when combine 100 is about to begin traversing field 205 at a second plurality of crop rows 203B, the second field condition being a presence of crop material 206 in forward path of travel 202. Combine 100 includes a front portion 109, lidar sensor 107 being attached to the front portion 109.

It is to be understood that the steps of the method of controllably performing work are performed by controller 108 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by controller 108 described herein, such as the method of controllably performing work, is implemented in software code or instructions which are tangibly stored on a tangible computer readable medium. The controller 108 loads the software code or instructions via a direct interface with the computer readable medium or via a wired and/or wireless network. Upon loading and executing such software code or instructions by controller 108, controller 108 may perform any of the functionality of controller 108 described herein, including any steps of the method of controllably performing work described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein, but is intended to include all changes and modifications that are within the scope and spirit of the invention.

What is claimed is:

1. A control system of an agricultural harvester for controllably harvesting a crop material, the control system comprising:
a lidar sensor configured for sensing a field condition in a forward path of travel of the agricultural harvester and thereby for outputting a field condition signal corresponding thereto; and
a controller operatively coupled with the lidar sensor and a header assembly of the agricultural harvester configured for removing the crop material from a field, the controller configured for receiving the field condition signal and for outputting an adjustment signal to raise the header assembly, based at least partially on the field condition signal, when the agricultural harvester reaches an end of a plurality of crop rows.

2. The control system of claim 1, wherein the field condition is a first field condition, the field condition signal being a first field condition signal, the adjustment signal being a first adjustment signal, the plurality crop rows being a first plurality of crop rows, the first field condition being an absence of the crop material in the forward path of travel.

3. The control system of claim 2, wherein the first field condition signal is associated with at least one of a predetermined threshold crop height and a predetermined threshold change in a distance sensed by the lidar sensor.

4. The control system of claim 3, wherein the lidar sensor is configured for sensing a second field condition in the forward path of travel of the agricultural harvester and thereby for outputting a second field condition signal corresponding thereto, the controller configured for receiving the second field condition signal and for outputting a second adjustment signal to lower the header assembly, based at least partially on the second field condition signal, when the agricultural harvester is about to begin traversing the field at a second plurality of crop rows, the second field condition being a presence of the crop material in the forward path of travel.

5. The control system of claim 2, wherein the lidar sensor is configured for being attached to a front portion of the agricultural harvester.

6. An agricultural harvester, comprising:
a header assembly configured for removing a crop material from a field;
a lidar sensor configured for sensing a field condition in a forward path of travel of the agricultural harvester and thereby for outputting a field condition signal corresponding thereto; and
a controller operatively coupled with the lidar sensor and the header assembly, the controller configured for receiving the field condition signal and for outputting an adjustment signal to the header assembly to raise the header assembly, based at least partially on the field condition signal, when the agricultural harvester reaches an end of a plurality of crop rows.

7. The agricultural harvester of claim 6, wherein the field condition is a first field condition, the field condition signal being a first field condition signal, the adjustment signal being a first adjustment signal, the plurality of crop rows being a first plurality of crop rows, the first field condition being an absence of the crop material in the forward path of travel.

8. The agricultural harvester of claim 7, wherein the first field condition signal is associated with at least one of a predetermined threshold crop height and a predetermined threshold change in a distance sensed by the lidar sensor.

9. The agricultural harvester of claim 8, wherein the lidar sensor is configured for sensing a second field condition in the forward path of travel of the agricultural harvester and thereby for outputting a second field condition signal corresponding thereto, the controller configured for receiving the second field condition signal and for outputting a second adjustment signal to lower the header assembly, based at least partially on the second field condition signal, when the agricultural harvester is about to begin traversing the field at a second plurality of crop rows, the second field condition being a presence of the crop material in the forward path of travel.

10. The agricultural harvester of claim 7, further comprising a front portion, the lidar sensor being attached to the front portion.

11. A method of controllably operating an agricultural harvester, the method comprising the steps of:
providing that the agricultural harvester includes a header assembly which is configured for removing a crop material from a field;
sensing, by a lidar sensor, a field condition in a forward path of travel of the agricultural harvester;
outputting, by the lidar sensor, a field condition signal corresponding to the field condition;
receiving, by a controller operatively coupled with the lidar sensor and the header assembly, the field condition signal; and
outputting, by the controller, an adjustment signal to the header assembly and thereby raising the header assembly, based at least partially on the field condition signal, when the agricultural harvester reaches an end of a plurality of crop rows.

12. The method of claim 11, wherein the field condition is a first field condition, the field condition signal being a first field condition signal, the adjustment signal being a first adjustment signal, the plurality of crop rows being a first plurality of crop rows, the first field condition being an absence of the crop material in the forward path of travel.

13. The method of claim 12, wherein the first field condition signal is associated with at least one of a predetermined threshold crop height and a predetermined threshold change in a distance sensed by the lidar sensor.

14. The method of claim 13, further comprising the steps of:
sensing, by the lidar sensor, a second field condition in the forward path of travel of the agricultural harvester;
outputting, by the lidar sensor, a second field condition signal corresponding to the second field condition;
receiving, by the controller, the second field condition signal;
outputting, by the controller, a second adjustment signal to the header assembly and thereby lowering the header assembly, based at least partially on the second field condition signal, when the agricultural harvester is about to begin traversing the field at a second plurality of crop rows, the second field condition being a presence of the crop material in the forward path of travel.

15. The method of claim 12, the agricultural harvesting including a front portion, the lidar sensor being attached to the front portion.
